(19) United States
(12) Patent Application Publication
(10) Pub. No.: US 2025/0243380 A1
(43) Pub. Date: Jul. 31, 2025

(54) Non-skid surface structure epoxy tile/mat

(71) Applicant: Adrian C. Corder, Hawthorne, CA (US)

(72) Inventor: Adrian C. Corder, Hawthorne, CA (US)

(21) Appl. No.: 18/445,772

(22) Filed: Jan. 29, 2024

(51) Int. Cl. C09D 163/00; B32B 7/12; B32B 25/04; C08J 7/04; C08J 7/043; C09D 5/00; C09D 7/65; E04F 15/02; E04F 15/10

(52) U.S. Cl. CPC C09D 163/00; B32B 7/12; B32B 25/042; C08J 7/042; C08J 7/043; C09D 5/002; C09D 7/65; E04F 15/0215; E04F 15/02188; E04F 15/102; B32B 2250/02; B32B 2255/10; B32B 2255/26; B32B 2255/28; B32B 2419/04; B32B 2471/04; C08J 2321/00; C08J 2463/00

(57) ABSTRACT

A non-slip, water resistant, oil resistant surface structure for use where water and/or oil are likely to create a slippery surface, including a rubber-bottom mat upon which a coated non-slip surfaced substrate is fastened. The coating on the substrate including crushed walnut shells, granules or the equivalent to provide for a non-slip surface and the coating comprising a thermosetting epoxy resin material with an amine hardener.

This is a patented invention, Inventor: Adrian C. Corder, U.S. Pat. No. 6,399,181. With a new base that is made of a mixture of crushed walnut shells, silica sand, granule quartz, rubber and epoxy when mixed all together, dry and harden. This mixture becomes a durable base that epoxy, paint and other materials can bone to. The base is the main supporting member and upon which and over which one or more layers of coating material are applied. You can spray, roll, trowel, pour or broadcast onto the base. Any corporations that make thermosetting HI BILD epoxy resin an amine hardener material can be used.

### BACKGROUND OF THE INVENTION

The present invention is directed to a non-skid surface structure that can be used as an epoxy floor tile or an epoxy floor mat for placement on garage floors, industrial floors and more. With the rubber bottom epoxy floor mats and epoxy floor tiles can be used on all floors, stairs, and other surfaces. Various non-skid surface structures are known, however none of these structures provide the combination of features yielding the usefulness, flexibility, durability, case of manufacture, and practicality of the epoxy floor mat and epoxy floor tiles present invention.

### Base Material

1st Coating—Thermosetting epoxy resin material, Part A and Part B (An Epoxy Resin and Amine Hardener). 2nd Coating—substrate coated in Part A and Part B (An Epoxy Resin and Amine Hardener) over 1st coating.

### Epoxy Coated Base Material

3rd Coating—Thermosetting epoxy resin material, Part A and Part B containing granule material or crushed walnut shells.

### Epoxy Containing Base Material Containing Granule or Crushed Walnut Shells

Attach base to a conventional rubber bottom and mat by conventional means.

### Decorative Non-Skid Water Resistant, Oil Resistant Surface Structure

### OBJECTS AND SUMMARY OF THE INVENTION

With beautiful art and designs it is an object of the present invention to provide a non-slip, water resistant, and oil resistant surface structure that can be used as an epoxy floor tile or as an epoxy floor mat for placement on garage floor and other flat surfaces. With reference to the above described object, the present invention provides the method of manufacture of the present surface structure includes coating a base material, preferably rubber with a thermosetting epoxy resin, and then coating the base material and allowing both to dry until the coating hardens. The coat hardened base material is then coated with a third coating of the thermosetting epoxy resin, which third coat contains abrasive materials such as crushed walnut shells or other granular materials and then allowing the third coating to dry and harden. The coated base, granular coated substrate is then fastened to a conventional rubber-bottomed mat with an appropriate adhesive and/or conventional fasteners. The size, depth, width, length and thickness of the surface structure may vary.

### THE PREFERRED EMBODIMENTS

The method of manufacture of the surface structure of the present invention will be described. First a substrate or sheet is selected, preferably the substrate is rubber board or other durable, flat material. The substrate base functions as a main supporting member and upon which and over which one or more layers of coating material are applied. 1st coating is a mixture of part A and part B thermosetting epoxy resin. Once the mixture is prepared, the substrate is coated with the mixture and permitted to dry, so that the coating hardens. The 2nd coating is a mixture of part A and part B thermosetting epoxy resin, a HI BILD epoxy resin, Once the mixture is prepared, the substrate is coated again with the mixture and permitted to dry. You can spray, roll, trowel, pour or broadcast these steps/systems the 3rd coating is applied. In this third coating a third mixture of the thermosetting epoxy resin HI BILD part A and part B and amine hardener is prepared. To this third mixture a quantity of crushed walnut shells or other granular materials are added. In addition to crushed walnut shells, granules are preferred. The granular material is mixed, preferably at a concentration of approximately ½ pound of granular material per gallon of the thermosetting epoxy resin and amine hardener part A and part B mixture. The amount of granular material added may vary but must be at least enough to provide the function of yielding a non-slip surface in the finished product but not so much granular material that the epoxy coating is unable to provide a coating that will adhere to the substrate. The mixture containing the granular material is then applied to the coated base material and the coating is allowed to dry and harden, thus forming a base material having three coatings, one of which contains HI BILD part A and part B thermosetting epoxy resin and amine hardener, second one of which contains base HI BILD part A and part B thermosetting epoxy resin and the third one of which contains granular material. Once the three times coated substrate is dried, it is fastened to a conventional rubber-bottom then the structure becomes an epoxy floor mat or epoxy floor tile. Once the three times coated substrate is dried, it has been made to size or cut to size and put adhesive on the back of the epoxy floor tile. When ready to use, peel off paper to uncover the adhesive and place the epoxy floor tile down on a clean surface or put adhesive down on a clean surface first then place epoxy floor tile down. Adhesives may be used in the present invention. So long as they function to adhere. the coated substrate to the rubber-bottom structure. The size, depth, width, length and thickness of the structure and its various components can vary, according to the particular application chosen. Such variances are within the skill of the art in this field. One of the advantages of the present inventions is that a non-skid surface substrate may be easily manufactured to conform to the dimensions of commercially available rubber mats. And to thereby provide a non-skid function for such surface structures when used in locations where the presence of oil, water and other such liquids might cause a slippery surface. As may be appreciated, and as believed to be within the capability of those skilled in this field, the epoxy floor mats can be made to have different shapes, colors and structures that provide for interlocking sections to each other and in various configurations. Also, although rubber is the preferred bottom material, other elastomeric materials may be used, so long as they are durable in the chosen environment and are able to be fastened to the created substrate. It will be understood that certain features and sub combinations are of utility and may be employed without reference to other features and sub combinations as they are outlined within the description above and within the claims appended hereto. While the preferred embodiments and application of the invention have been described, it is apparent to those skilled in the art that the objects and features of the present invention are only limited as set forth in the claims appended hereto.

I claim:

1. A method of making a surface structure compressing:
Selecting a base material made of rubber, crushed walnut shells, silica sand, granule quartz, epoxy and applying a first coating of a thermosetting epoxy resin and amine hardener to said base material: apply a second coating including a substrate coated in thermosetting epoxy resin material to provide a twice-coated base material; permitting said twice-coated base material to dry and harden; preparing a mixture of epoxy resin and amine hardener containing granular materials in an amount effective to from a roughened surface to form a third coating material when hardened; applying the third coating material to the twice-coated base material; permitting said third coating material to harden and dry form a rough coated base; and attaching said rough coated base to rubber-bottomed mat.

2. The method of claim wherein the granular material includes crushed walnut shells.

3. A surface structure comprising: a rubber-bottomed mat adhered to a twice-coated substrate; the twice-coated substrate having an epoxy resin based first coating, an epoxy resin based second coating including a substrate coated in an epoxy resin over base first coating and an epoxy resin based third coating including a predetermined amount of granular material.

4. The surface structure of claim wherein the rubber-bottomed mat is adhered to the substrate with an adhesive.

5. The surface structure of the claim wherein the substrate is made of rubber.

6. The surface structure of claim wherein the granular material includes crushed walnut shells.

7. The surface structure of claim wherein the granular material is in a concentration of about ½ pound per gallon of the third coating.

8. The surface structure of the claim has a first section, a second section separating the first section from the second section.

9. The surface structure of claim wherein the surface structure is an epoxy floor tile.

10. The surface structure of claim wherein the surface structure is an epoxy floor mat.

11. The surface structure of claim wherein the durable base that other material can bond to.
